(19) United States
(12) Patent Application Publication
(10) Pub. No.: US 2011/0028358 A1
(43) Pub. Date: Feb. 3, 2011

(54) Methods of Fluid Loss Control and Fluid Diversion in Subterranean Formations

(76) Inventors: Thomas D. Welton, Duncan, OK (US); Bradley L. Todd, Duncan, OK (US)

Correspondence Address: ROBERT A. KENT, P.O. BOX 1431, DUNCAN, OK, 73536, US

(21) Appl. No.: 12/512,232

(22) Filed: Jul. 30, 2009

(51) Int. Cl. C09K 8/68

(52) U.S. Cl. 507/219; 507/200; 507/236; 507/237; 507/241; 507/263; 507/266

(57) ABSTRACT

Improved methods of placing and/or diverting treatment fluids in subterranean formations are provided. In one embodiment, the methods comprise introducing a treatment fluid into a subterranean formation penetrated by a well bore, wherein the treatment fluid comprises: a base fluid, and a plurality of solid particulates comprising at least one selected from the group consisting of: a scale inhibitor, a chelating agent, and a combination thereof, wherein the solid particulates are substantially insoluble in the base fluid; and allowing at least a portion of the solid particulates to form a barrier or at partially divert a subsequent fluid.

### BACKGROUND

The present invention relates to methods that may be useful in treating subterranean formations, and more specifically, to methods of controlling fluid loss and/or diverting treatment fluids in subterranean formations.

Treatment fluids may be used in a variety of subterranean treatments, including, but not limited to, stimulation treatments and sand control treatments. As used herein, the term “treatment,” or “treating,” refers to any subterranean operation that uses a fluid in conjunction with a desired function and/or for a desired purpose. The terms “treatment,” and “treating,” as used herein, do not imply any particular action by the fluid or any particular component thereof. Examples of common subterranean treatments include, but are not limited to, drilling operations, fracturing operations (including prepad, pad and flush), perforation operations, sand control treatments (e.g., gravel packing, resin consolidation including the various stages such as preflush, afterflush, etc.), acidizing treatments (e.g., matrix acidizing or fracture acidizing), “frac-pack” treatments, cementing treatments, water control treatments, well bore clean-out treatments, paraffin/wax treatments, scale treatments and “squeeze treatments.”

In subterranean treatments, it is often desired to treat an interval of a subterranean formation having sections of varying permeability, reservoir pressures and/or varying degrees of formation damage, and thus may accept varying amounts of certain treatment fluids. For example, low reservoir pressure in certain areas of a subterranean formation or a rock matrix or a proppant pack of high permeability may permit that portion to accept larger amounts of certain treatment fluids. It may be difficult to obtain a uniform distribution of the treatment fluid throughout the entire interval. For instance, the treatment fluid may preferentially enter portions of the interval with low fluid flow resistance at the expense of portions of the interval with higher fluid flow resistance. In some instances, these intervals with variable flow resistance may be water-producing intervals.

In conventional methods of treating such subterranean formations, once the less fluid flow-resistant portions of a subterranean formation have been treated, that area may be sealed off using a variety of techniques to divert treatment fluids to more fluid flow-resistant portions of the interval. Such techniques may have involved, among other things, the injection of particulates, foams, emulsions, plugs, packers, or blocking polymers (e.g., crosslinked aqueous gels) into the interval so as to plug off high-permeability portions of the subterranean formation once they have been treated, thereby diverting subsequently injected fluids to more fluid flow-resistant portions of the subterranean formation.

In addition to diverting a treatment fluid in a subterranean formation, it may also be desirable to provide effective fluid loss control for subterranean treatment fluids. “Fluid loss,” as that term is used herein, refers to the undesirable migration or loss of fluids into a subterranean formation and/or a proppant pack. The term “proppant pack,” as used herein, refers to a collection of a mass of proppant particulates within a fracture or open space in a subterranean formation. Fluid loss may be problematic in any number of subterranean operations, including drilling operations, fracturing operations, acidizing operations, gravel-packing operations, well bore clean-out operations, and the like. In fracturing treatments, for example, fluid loss into the formation may result in a reduction in fluid efficiency, such that the fracturing fluid cannot propagate the fracture as desired.

Fluid loss control materials are additives that lower the volume of a filtrate that passes through a filter medium. Certain particulate materials may be used as a fluid loss control material in subterranean treatment fluids to fill the pore spaces in a formation matrix and/or proppant pack and/or to contact the surface of a formation face and/or proppant pack, thereby forming a filter cake that blocks the pore spaces in the formation or proppant pack, and prevents fluid loss therein. However, the use of certain particulate fluid loss control materials may be problematic. For instance, the sizes of the particulates may not be optimized for the pore spaces in a particular formation matrix and/or proppant pack and, as a result, may increase the risk of invasion of the particulate material into the interior of the formation matrix, which may greatly increase the difficulty of removal by subsequent remedial treatments. Additionally, once fluid loss control is no longer required, for example, after completing a treatment, remedial treatments may be required to remove the previously-placed fluid loss control materials, inter alia, so that a well may be placed into production. However, particulates that have become lodged in pore spaces and/or pore throats in the formation matrix and/or proppant pack may be difficult and/or costly to remove.

### SUMMARY

The present invention relates to methods that may be useful in treating subterranean formations, and more specifically, to methods of controlling fluid loss and/or diverting treatment fluids in subterranean formations.

In one embodiment, the methods of the present invention provide a method comprising introducing a treatment fluid into a subterranean formation penetrated by a well bore, wherein the treatment fluid comprises: a base fluid, and a plurality of solid particulates comprising at least one selected from the group consisting of: a scale inhibitor, a chelating agent, and a combination thereof, wherein the solid particulates are substantially insoluble in the base fluid; and allowing at least a portion of the solid particulates to form a barrier.

In another embodiment, the methods of the present invention provide a method comprising introducing a treatment fluid into a subterranean formation penetrated by a well bore, wherein the treatment fluid comprises: a base fluid, and a plurality of solid particulates comprising a scale inhibitor, wherein the solid particulates are substantially insoluble in the base fluid, and wherein the treatment fluid does not comprise any proppant particulates; and allowing at least a portion of the solid particulates to form a barrier.

In yet another embodiment, the methods of the present invention provide a method comprising introducing a treatment fluid into a subterranean formation penetrated by a well bore at a pressure at or above the fracture pressure of the subterranean formation, wherein the treatment fluid comprises: a base fluid, and a plurality of solid particulates comprising at least one selected from the group consisting of a scale inhibitor, a chelating agent, and a combination thereof, wherein the solid particulates are substantially insoluble in the base fluid; and allowing at least a portion of the solid particulates to form a barrier.

The features and advantages of the present invention will be readily apparent to those skilled in the art. While numerous changes may be made by those skilled in the art, such changes are within the spirit of the invention.

### DESCRIPTION OF PREFERRED EMBODIMENTS

The present invention relates to methods that may be useful in treating subterranean formations, and more specifically, to methods of controlling fluid loss and/or diverting treatment fluids in subterranean formations.

The methods of the present invention generally comprise: introducing a treatment fluid into a subterranean formation penetrated by a well bore, wherein the treatment fluid comprises: a base fluid and a plurality of solid particulates comprising a scale inhibitor or a chelating agent, wherein the particulates are substantially insoluble in the base fluid; and allowing the plurality of particulates to form a barrier to at least partially divert a treatment fluid and/or at least partially control fluid loss. As used in this disclosure, the term “barrier” refers to a partial or complete obstruction or impediment to the passage of a substance through an area for a desired period of time. Following completion, the solid particulates may be contacted with a solubilizing agent for a sufficient period of time such that at least a portion of the particulates are solubilized. It should be understood that the term “particulate,” as used in this disclosure, includes all known shapes of materials including substantially spherical materials, fibrous materials, flacks, polygonal materials (such as cubic materials) and mixtures thereof. As used in this disclosure, “substantially insoluble” refers to less than about 1% weight percent soluble in distilled water at room temperature (about 72° F.) for the anticipated duration of the treatment. The treatment fluids of the present invention may be used in a variety of subterranean applications including, but not limited to, drilling operations, fracturing operations (including prepad, pad and flush), perforation operations, sand control treatments (e.g., gravel packing, resin consolidation including the various stages such as preflush, afterflush, etc.), acidizing treatments (e.g., matrix acidizing or fracture acidizing), “frac-pack” treatments, cementing treatments, water control treatments, well bore clean-out treatments, paraffin/wax treatments, scale treatments, “squeeze treatments” and as a fluid loss pill.

Among the many advantages of the present invention, in certain embodiments, the methods of the present invention may reduce or prevent loss of fluid into a subterranean formation (for example, to less than about 10 barrels of fluid per hour.) In addition, in some embodiments, the methods of the present invention may facilitate improved control over the placement of treatment fluids in a subterranean formation, increased fluid efficiency in various subterranean treatments, diversion of subsequently injected fluids to other portions of the subterranean formation, and/or more complete treatment of certain portions of a subterranean formation. In addition to these benefits, in some embodiments, treatment fluids comprising a scale inhibitor may also provide a further benefit, such as scale inhibition. Furthermore, in certain embodiments, the treatment fluids may be removed from a subterranean formation without the need for additional breakers or other additives.

Treatment fluids suitable for use in the present invention generally comprise a base fluid and a plurality of particulates comprising a scale inhibitor and/or a chelating agent, wherein the particulates are substantially insoluble in the base fluid. Suitable base fluids may include aqueous fluids such as freshwater, saltwater, brine, seawater, produced water, chelate solutions, and acidic solutions (e.g., hydrochloric acid, acetic acid, formic acid, lactic acid, hydrofluoric acid, boronic acid, etc.). Suitable base fluids may also include nonaqueous fluids such as hydrocarbon based fluids (e.g., diesel, glycols). Generally, the base fluid may be from any source, provided that it does not contain components that may adversely affect other components in the treatment fluid. Similarly, the treatment fluids of the present invention may be foamed or unfoamed. One of ordinary skill in the art with the benefit of this disclosure would be able to select an appropriate base fluid based on the application in which the treatment fluid would be used, the type of particulates used, etc.

As described above, in one embodiment, the treatment fluids of the present invention may comprise a plurality of particulates comprising a scale inhibitor, wherein the particulates are substantially insoluble in the base fluid. In general, suitable scale inhibitors for use in the present invention may be any scale inhibitor in particulate form that is substantially insoluble in the base fluid. Suitable scale inhibitors generally include, but are not limited to bis(hexamethylene triamine penta(methylene phosphonic acid)); diethylene triamine penta(methylene phosphonic acid); ethylene diamine tetra(methylene phosphonic acid); hexamethylenediamine tetra(methylene phosphonic acid); 1-hydroxy ethylidene-1,1-diphosphonic acid; 2-hydroxyphosphonocarboxylic acid; 2-phosphonobutane-1,2,4-tricarboxylic acid; phosphino carboxylic acid; diglycol amine phosphonate; aminotris(methanephosphonic acid); methylene phosphonates; phosphonic acids; aminoalkylene phosphonic acids; aminoalkyl phosphonic acids; polyphosphates, salts thereof (such as but not limited to: sodium, potassium, calcium, magnesium, ammonium); and combinations thereof.

In some embodiments, the treatment fluids of the present invention may comprise a plurality of particulates comprising a chelating agent, wherein the particulates are substantially insoluble in the base fluid. The chelating agents useful in the present invention may be any suitable chelating agent in particulate form that is substantially insoluble in the base fluid. Suitable chelating agents generally include, but are not limited to, the acidic forms of the following: ethylenediaminetetraacetic acid (EDTA), hydroxyethyl ethylenediamine triacetic acid (HEDTA), nitrilotriacetic acid (NTA), diethylene triamine pentaacetic acid (DTPA), glutamic acid diacetic (GLDA), glucoheptonic acid (CSA), propylene diamine tetraacetic acid (PDTA), ethylenediaminedisuccinic acid (EDDS), diethanolglycine (DEG), ethanoldiglycine (EDG), glucoheptonate, citric acid, malic acid, phosphates, amines, citrates, and combinations and derivatives thereof. Other suitable chelating agents may include the acidic forms of chelating agents classified as polyphosphates, aminocarboxylic acids, aminopolycarboxylates, 1,3-diketones, hydroxycarboxylic acids, polyamines, aminoalcohols, aromatic heterocyclic bases, phenols, aminophenols, oximes, Schiff bases, tetrapyrroles, sulfur compounds, synthetic macrocyclic compounds, polymers, phosphonic acids, and combinations and derivatives thereof.

In general, particulates comprising a scale inhibitor and/or a chelating agent suitable for use in the present invention are substantially insoluble in a base fluid, but are substantially soluble when contacted with a solubilizing agent. Therefore, in certain embodiments, once the treatment operation has been completed, a solubilizing agent may be introduced into the well bore (or may be already present in the subterranean formation) whereby the particulate comprising a scale inhibitor or a chelating agent is dissolved. In some embodiments, the solubilizing agent may have the effect of causing the particulate comprising a scale inhibitor and/or a chelating agent to form its free acid, to dissolve, to hydrolyze into solution, to form its salt, to change salts, etc. and thereby become soluble. After a chosen time, the treatment fluid of the present invention may be recovered through the well bore that penetrates the subterranean formation. Suitable solubilizing agents include salts, including ammonium salts, aqueous fluids (e.g., brine), formation fluids (e.g., produced formation water, returned load water, etc.), acidic fluids, and spent acid. The type of solubilizing agent used generally depends upon the type of particulate to be solubilized. For example, solubilizing agents comprising acidic fluids may be suitable for use with polymeric scale inhibitors. One of ordinary skill in the art with the benefit of this disclosure will be able to select an appropriate solubilizing agent based on the type of scale inhibitor and/or chelating agent used.

In some embodiments, particulates comprising a scale inhibitor and/or a chelating agent may be present in the treatment fluids of the present invention in an amount in the range of from about 0.5% to about 15% by weight of the treatment fluid. In other embodiments, the particulates may be present in the treatment fluids of the present invention in an amount of from about 0.5% to about 5% by weight of the treatment fluids.

As mentioned above, the treatment fluids of the present invention generally comprise a plurality of substantially insoluble particulates comprising a scale inhibitor and/or a chelating agent. The size of the particulates present in the treatment fluid may vary depending upon the application in which they will be used, the type of base fluid, screen size, slot size, and the pore sizes, proppant sizes, and/or permeability of the formation. For example, in those embodiments where the base fluid is an acidic solution, the particulates may have a size in the range of from about 1000 microns to 2 microns. In some embodiments where the base fluid is an acidic solution, the particulates may have a size in the range of from about 150 microns to 15 microns. In other embodiments where the base fluid is a nonacidic fluid, the particulates may have a size in the range of from about 150 microns to 2 microns. In those treatment fluids which also comprise proppant, the particulates comprising a scale inhibitor or a chelating agent may be smaller than the proppant. One of ordinary skill in the art with the benefit of this disclosure will be able to select an appropriate size for the substantially insoluble particulates based on the factors mentioned above.

Additional additives may be included in the treatment fluids of the present invention as deemed appropriate for a particular application by one skilled in the art, with the benefit of this disclosure. Examples of such additives include, but are not limited to, acids, weighting agents, surfactants, antifoaming agents, bactericides, salts, foaming agents, fluid loss control additives, relative permeability modifiers, viscosifying agents, proppant particulates, gel breakers, clay stabilizers, friction reducers, corrosion inhibitors, cross-linking agents, scale inhibitors, chelating agents, and combinations thereof. Additionally, in some embodiments, the treatment fluids of the present invention may comprise no proppant particulates.

In some embodiments, the treatment fluids may optionally comprise an acid generating compound. Examples of acid generating compounds that may be suitable for use in the present invention include, but are not limited to, esters, aliphatic polyesters, ortho esters, which may also be known as ortho ethers, poly(ortho esters), which may also be known as poly(ortho ethers), poly(lactides), poly(glycolides), poly(ε-caprolactones), poly(hydroxybutyrates), poly(anhydrides), or copolymers thereof. Derivatives and combinations also may be suitable. The term “copolymer” as used herein is not limited to the combination of two polymers, but includes any combination of polymers, e.g., terpolymers and the like. Other suitable acid-generating compounds include: esters including, but not limited to, ethylene glycol monoformate, ethylene glycol diformate, diethylene glycol diformate, glyceryl monoformate, glyceryl diformate, glyceryl triformate, triethylene glycol diformate and formate esters of pentaerythritol. Other suitable materials may be disclosed in U.S. Pat. Nos. 6,877,563 and 7,021,383, the disclosures of which are incorporated by reference.

In some embodiments, particulates comprising a scale inhibitor and/or a chelating agent suitable for use in the present invention may be at least partially coated and/or encapsulated with slowly water soluble or other similar encapsulating materials. Such materials are well known to those skilled in the art. Examples of water soluble and other similar encapsulating materials which can be utilized include, but are not limited to, porous solid materials such as precipitated silica, elastomers, polyvinylidene chloride (PVDC), nylon, waxes, polyurethanes, cross-linked partially hydrolyzed acrylics and the like.

The treatment fluids of the present invention may be used for diversion in a variety of subterranean operations. In some embodiments, the methods comprise: providing a treatment fluid of the present invention that comprises a base fluid and a plurality of particulates comprising a scale inhibitor and/or a chelating agent, wherein the particulates are substantially insoluble in the base fluid; introducing the treatment fluid into a well bore that penetrates a subterranean formation; and allowing at least a first portion of the treatment fluid to penetrate into a portion of the subterranean formation so that the particulates present in the portion of the subterranean formation substantially divert a second portion of the treatment fluid or another fluid to another portion of the subterranean formation. Among other things, the presence of the particulates in the portion of the subterranean formation should form a barrier such that any fluid subsequently introduced into the well bore should be substantially diverted to another portion of the subterranean formation. Additionally, particulates comprising scale inhibitors may also provide the additional benefit of inhibiting scale formation.

In some embodiments, the plurality of particulates comprising a scale inhibitor and/or a chelating agent may be mixed with the base fluid and introduced into a portion of the subterranean formation between stages of a treatment or as a pretreatment. In some embodiments, the treatment fluids of the present invention may be self-diverting. For example, in some embodiments, the plurality of particulates comprising a scale inhibitor and/or a chelating agent may be included in the treatment fluid during the subterranean treatment. In these embodiments, the plurality of particulates comprising a scale inhibitor and/or a chelating agent may progressively divert the treatment fluid to another portion of the subterranean formation. For instance, in some embodiments, as a first portion of the treatment fluid penetrates into a portion of the subterranean formation a second portion of the treatment fluid may be diverted to another portion of the subterranean formation.

In addition to diversion, the particulates comprising a scale inhibitor or a chelating agent of the present invention may be added to any treatment fluid in which it is desirable to control fluid loss. Examples may include, but are not limited to, fracturing fluids, drill-in fluids, gravel pack fluids, and fluid loss control pills. Hydraulic fracturing operations are stimulation techniques that generally involve pumping a treatment fluid (e.g., a fracturing fluid) into a well bore that penetrates a subterranean formation at a sufficient hydraulic pressure to create or enhance one or more cracks, or “fractures,” in the subterranean formation. The fracturing fluid may comprise particulates, often referred to as “proppant,” that are deposited in the fractures. The proppant particulates, inter alia, prevent the fractures from fully closing upon the release of hydraulic pressure, forming conductive channels through which fluids may flow to the well bore. Once at least one fracture is created or enhanced and the proppant particulates are substantially in place, the fracturing fluid may be “broken” (i.e., the viscosity is reduced), and the fracturing fluid may be recovered from the formation. Any fracturing fluid that is suitable for use in subterranean formations may be used in conjunction with the present invention.

The methods of the present invention may be used prior to, during, or subsequent to a variety of subterranean operations known in the art. Examples of such operations include, but are not limited to, drilling operations, fracturing operations (including prepad, pad and flush), perforation operations, sand control treatments (e.g., gravel packing, resin consolidation including the various stages such as preflush, afterflush, etc.), acidizing treatments (e.g., matrix acidizing or fracture acidizing), “frac-pack” treatments, cementing treatments, water control treatments, well bore clean-out treatments, paraffin/wax treatments, scale treatments, and “squeeze treatments.”

In some embodiments, the treatment fluids of the present invention may be placed into the subterranean formation at a pressure below the fracture pressure of the subterranean formation. In some embodiments, the treatment fluids of the present invention may be placed into the subterranean formation at a pressure above the fracture pressure of the subterranean formation. In some embodiments, the treatment fluids of the present invention may be placed into the subterranean formation at a pressure equal to the fracture pressure of the subterranean formation. A person of ordinary skill in the art with the benefit of this disclosure would be able to determine a suitable pressure for any given application or subterranean formation.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an”, as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

What is claimed is:

1. A method comprising:
introducing a treatment fluid into a subterranean formation penetrated by a well bore, wherein the treatment fluid comprises:
a base fluid, and
a plurality of solid particulates comprising at least one selected from the group consisting of: a scale inhibitor, a chelating agent, and a combination thereof, wherein the solid particulates are substantially insoluble in the base fluid; and
allowing at least a portion of the solid particulates to form a barrier that at least partially reduces the passage of the base fluid or a subsequent fluid into the subterranean formation.

2. The method of claim 1 further comprising allowing a solubilizing agent to solubilize at least a portion of the solid particulates.

3. The method of claim 1 wherein the base fluid comprises at least one fluid selected from the group consisting of: freshwater, saltwater, brine, seawater, produced water, a chelate solution, an acidic solution and a hydrocarbon based fluid.

4. The method of claim 1 wherein the solid particulates comprise at least one scale inhibitor selected from the group consisting of: bis(hexamethylene triamine penta(methylene phosphonic acid)), diethylene triamine penta(methylene phosphonic acid), ethylene diamine tetra(methylene phosphonic acid), hexamethylenediamine tetra(methylene phosphonic acid), 1-hydroxy ethylidene-1,1-diphosphonic acid, 2-hydroxyphosphonocarboxylic acid, 2-phosphonobutane-1,2,4-tricarboxylic acid, phosphino carboxylic acid, diglycol amine phosphonate, aminotris(methanephosphonic acid), a methylene phosphonate, a phosphonic acid, an aminoalkylene phosphonic acid, an aminoalkyl phosphonic acid, a polyphosphate, a salt thereof, a combination thereof, and a derivative thereof.

5. The method of claim 1 wherein the solid particulates comprise at least one chelating agent selected from the group consisting of the acidic forms of the following: ethylenediaminetetraacetic acid, hydroxyethyl ethylenediamine triacetic acid, nitrilotriacetic acid, diethylene triamine pentaacetic acid, glutamic acid diacetic, glucoheptonic acid, propylene diamine tetraacetic acid, ethylenediaminedisuccinic acid, diethanolglycine, ethanoldiglycine, glucoheptonate, citric acid, malic acid, a phosphates, an amine, a citrate, a polyphosphate, an aminocarboxylic acid, a polyaminopolycarboxylic acid, an aminopolycarboxylate, a 1,3-diketone, a hydroxycarboxylic acid, a polyamine, an aminoalcohol, an aromatic heterocyclic base, a phenol, an aminophenol, an oxime, a Schiff base, a tetrapyrrole, a sulfur compound, a synthetic macrocyclic compound, a polymer, a phosphonic acid, a salt thereof, a combination thereof, and a derivative thereof.

6. The method of claim 1 wherein at least a portion of the solid particulates are at least partially coated or encapsulated with an encapsulating material.

7. The method of claim 2 wherein the solubilizing agent comprises at least one solubilizing agent selected from the group consisting of: a salt, an aqueous fluid, a formation fluid, an acidic fluid, and spent acid.

8. The method of claim 1 wherein the solid particulates have a size in the range of from about 1000 microns to 2 microns.

9. The method of claim 1 wherein the solid particulates have a size in the range of from about 150 microns to 2 microns.

10. The method of claim 1 wherein the treatment fluid further comprises an acid generating compound.

11. A method comprising:
introducing a treatment fluid into a subterranean formation penetrated by a well bore, wherein the treatment fluid comprises:
a base fluid, and
a plurality of solid particulates comprising a scale inhibitor, wherein the solid particulates are substantially insoluble in the base fluid, and wherein the treatment fluid does not comprise any proppant particulates; and
allowing at least a portion of the solid particulates to form a barrier that at least partially reduces the passage of the base fluid or a subsequent fluid into the subterranean formation.

12. The method of claim 11 further comprising allowing a solubilizing agent to solubilize at least a portion of the solid particulates.

13. The method of claim 11 wherein the base fluid comprises at least one fluid selected from the group consisting of: freshwater, saltwater, brine, seawater, produced water, an acidic solution and a hydrocarbon based fluid.

14. The method of claim 11 wherein the solid particulates comprise at least one scale inhibitor selected from the group consisting of: bis(hexamethylene triamine penta(methylene phosphonic acid)), diethylene triamine penta(methylene phosphonic acid), ethylene diamine tetra(methylene phosphonic acid), hexamethylenediamine tetra(methylene phosphonic acid), 1-hydroxy ethylidene-1,1-diphosphonic acid, 2-hydroxyphosphonocarboxylic acid, 2-phosphonobutane-1,2,4-tricarboxylic acid, phosphino carboxylic acid, diglycol amine phosphonate, aminotris(methanephosphonic acid), a methylene phosphonate, a phosphonic acid, an aminoalkylene phosphonic acid, an aminoalkyl phosphonic acid, a polyphosphate, a salt thereof, a combination thereof, and a derivative thereof.

15. The method of claim 12 wherein the solubilizing agent comprises at least one solubilizing agent selected from the group consisting of: a salt, an aqueous fluid, a formation fluid, an acidic fluid, and spent acid.

16. The method of claim 11 wherein introducing the treatment fluid into the subterranean formation comprises introducing the treatment fluid into the subterranean formation at a pressure below the fracture pressure of the subterranean formation.

17. The method of claim 11 wherein the solid particulates have a size in the range of from about 1000 microns to 2 microns.

18. A method comprising:
introducing a treatment fluid into a subterranean formation penetrated by a well bore at a pressure at or above the fracture pressure of the subterranean formation, wherein the treatment fluid comprises:
a base fluid, and
a plurality of solid particulates comprising at least one selected from the group consisting of a scale inhibitor, a chelating agent, and a combination thereof, wherein the solid particulates are substantially insoluble in the base fluid; and
allowing at least a portion of the solid particulates to form a barrier that at least partially reduces the passage of the base fluid or a subsequent fluid into the subterranean formation.

19. The method of claim 18 further comprising allowing a solubilizing agent to solubilize at least a portion of the solid particulates.

20. The method of claim 18 wherein the base fluid comprises at least one fluid selected from the group consisting of: freshwater, saltwater, brine, seawater, produced water, a chelate solution, an acidic solution and a hydrocarbon based fluid.

21. The method of claim 18 wherein the solid particulates comprise at least one chelating agent selected from the group consisting of the acidic forms of the following: ethylenediaminetetraacetic acid, hydroxyethyl ethylenediamine triacetic acid, nitrilotriacetic acid, diethylene triamine pentaacetic acid, glutamic acid diacetic, glucoheptonic acid, propylene diamine tetraacetic acid, ethylenediaminedisuccinic acid, diethanolglycine, ethanoldiglycine, glucoheptonate, citric acid, malic acid, a phosphates, an amine, a citrate, a polyphosphate, an aminocarboxylic acid, a polyaminopolycarboxylic acid, an aminopolycarboxylate, a 1,3-diketone, a hydroxycarboxylic acid, a polyamine, an aminoalcohol, an aromatic heterocyclic base, a phenol, an aminophenol, an oxime, a Schiff base, a tetrapyrrole, a sulfur compound, a synthetic macrocyclic compound, a polymer, a phosphonic acid, a salt thereof, a combination thereof, and a derivative thereof.

22. The method of claim 19 wherein the solubilizing agent comprises at least one solubilizing agent selected from the group consisting of: a salt, an aqueous fluid, a formation fluid, an acidic fluid, and spent acid.

23. The method of claim 18 wherein the solid particulates have a size in the range of from about 150 microns to 2 microns.

24. The method of claim 18 wherein the treatment fluid further comprises proppant particulates.
